(19) United States
(12) Patent Application Publication
(10) Pub. No.: US 2007/0010279 A1
(43) Pub. Date: Jan. 11, 2007

(54) Anntena for radio base station and radio communication system

(75) Inventor: Naohiro Matsushita, Mishima (JP)

Correspondence Address: HARNESS, DICKEY & PIERCE, P.L.C., P.O. BOX 828, BLOOMFIELD HILLS, MI, 48303, US

(73) Assignee: Toshiba Tec Kabushiki Kaisha

(21) Appl. No.: 11/454,178

(22) Filed: Jun. 15, 2006

(30) Foreign Application Priority Data
Jun. 17, 2005 (JP) 2005-177958

(51) Int. Cl. H04B 7/00

(52) U.S. Cl. 455/523; 455/562.1; 343/771

(57) ABSTRACT

An antenna for a radio base station has a leaky coaxial cable transmitting transmission power toward a terminator and transmitting received power toward an input terminal, a low-loss coaxial cable having a transmission loss per unit length smaller than that of the leaky coaxial cable, a first directional coupler having a function to pass the transmission power advancing to the terminator and a function to output the received power advancing toward the input terminal to the outside, a second directional coupler having a function to pass the transmission power advancing to the terminator and a function to bypass and output the received power advancing to the input terminal to the low-loss coaxial cable, and a power compositor inputting the received power output from the first directional coupler and the received power from the low-loss coaxial cable and outputting its composite power.

### CROSS-REFERENCE TO RELATED APPLICATIONS

This application is based upon and claims the benefit of priority from prior Japanese Patent Application No. 2005-177958, filed Jun. 17, 2005, the entire contents of which are incorporated herein by reference.

### BACKGROUND OF THE INVENTION

1. Field of the Invention

The present invention relates to an antenna for a radio base station using a leaky transmission line and a radio communication system using the antenna.

2. Description of the Related Art

For instance, a radio system using a leaky transmission line such as a leaky coaxial cable for an antenna for a radio base station is disclosed in Jpn. Pat. Appln. KOKAI Publication No. 7-15378.

The radio system arranges a leaky coaxial cable exclusive for a transmission and a leaky coaxial cable exclusive for a received having a radiation efficiency higher than that of the coaxial cable exclusively for the transmission in parallel with each other and connects them to the a radio base station apparatus.

The base station uses the leaky coaxial cable exclusively for received having high radiation efficiency, so that the radio system can enhance a sensitivity of a receiving antenna.

Accordingly, the base station has an acting effect such that it efficiently receives a weak radio wave from a radio terminal having transmission power smaller than that of itself and can convert it into high-frequency power.

However, the leaky coaxial cable has a characteristic of principle that the larger the radiation efficiency is, the larger the transmission loss per unit length becomes.

According to the characteristic, if the leaky coaxial cable is as long as several hundreds meter, received power is extremely lost in a process of a cable transmission to the receiving unit of the base station, so that the radio station becomes impossible to make a sure received.

Therefore, an establishment of an interactive communication needs to shorten and limit the length of the leaky coaxial cable exclusively for received. As a result, the length of the antenna at the base station becomes short and a radio communication range of the base station becomes narrow.

### BRIEF SUMMARY OF THE INVENTION

According to an aspect of the present invention, there is provided an antenna for a radio base station, comprising a leaky transmission line which transmits transmission power from an input terminal to a terminator and transmits received power toward the input terminal; a low-loss transmission line with a transmission loss per unit length smaller than that of the leaky transmission line; a first directional coupler which is disposed near the input terminal of the leaky transmission line and has a function to pass the transmission power advancing from the input terminal to a terminator and a function to output the received power advancing to the input terminal to the outside; a second directional coupler which is disposed in the middle of the leaky transmission line and has a function to pass the transmission power advancing from the input terminal to the terminator and a function to bypass and output the received power advancing to the input terminal to the low-loss transmission line; and a power compositor which is disposed correspondingly to the first directional coupler, inputs the received power output from the first directional coupler and the received power from the low-loss transmission line and outputs its composite power to an output terminal.

Thereby, a radio base station can perform a sure received even if the length of the leaky transmission line is made sufficient long. And the radio communication range of the radio base station can be made fully wide.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary view depicting a structure of an antenna for a radio base station regarding a first embodiment of the invention;

FIG. 2 is an exemplary view depicting a structure of an antenna form a radio base station regarding a second embodiment of the invention;

FIG. 3 is an exemplary view depicting a configuration of a radio communication system using an antenna for a radio base station regarding a third embodiment of the invention; and

FIG. 4 is an exemplary view depicting a configuration of a radio communication system using an antenna for a radio base station regarding a fourth embodiment of the invention.

### DETAILED DESCRIPTION OF THE INVENTION

Hereinafter, embodiments of the present invention will be explained with reference to the drawings.

### First Embodiment

A first embodiment will set forth an antenna for a radio base station.

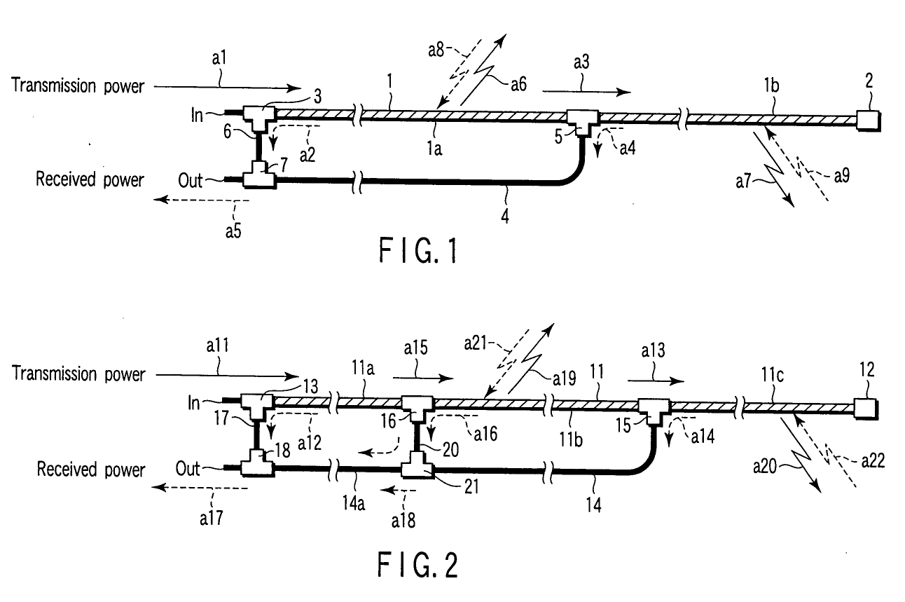

In FIG. 1, a leaky coaxial cable 1 constitutes a leaky transmission line. The transmission line may be constituted by something other than a leaky coaxial cable.

For example, the transmission line may be constituted by an open coaxial cable.

The coaxial cable 1 inputs transmission power from an input terminal IN to transmit it toward a terminator 2. The coaxial cable 1 transmits received power received from the outside toward the input terminal IN.

The coaxial cable 1 disposes a first directional coupler 3 near the input terminal IN.

The coupler 3 has a function to pass the transmission power advancing from the input terminal IN to the terminator 2 as shown by an arrow a1 of a solid line in the figure and a function to output the received power received from the outside and advanced to the input terminal IN to a below-mentioned power compositor as shown by an arrow a2 of a dot line in the figure.

The coaxial cable 1 disposes a second directional coupler 5 in the middle thereof.

The second coupler 5 has a function to pass the transmission power advancing from the input terminal IN to the terminator 2 as shown by an arrow a3 of a solid line in the figure and a function to bypass and output the received power received from the outside and advanced toward the input terminal IN to a low-loss coaxial cable 4 a as shown by an arrow a4 of a dot line in the figure.

The coaxial cable 4 constitutes a low-loss transmission line and has a transmission loss per unit length smaller than that of the coaxial cable 1. The low-loss transmission line may be constituted by something other than a low-loss coaxial cable.

For example, the low-loss transmission line may be constituted by a leaky wave guide.

A power compositor 7 is connected to the first coupler 3 through a coaxial 6 having an extremely small length.

The received power output from the first coupler 3 may be directly input to the power compositor 7 without using the coaxial cable 6.

The power compositor 7 is connected to the second coupler 5 via the coaxial cable 4.

The power compositor 7 inputs the received power output from the first coupler 3 via the coaxial cable 6 and also inputs the received power from the coaxial cable 4 to compose the two received power.

The power compositor 7 outputs the composite power as final received power to an output terminal OUT as shown by an arrow a5 of a dot line in the figure.

The transmission power input to the input terminal IN of the antenna for the radio base station structured like this is transmitted through the coaxial cable 1 toward the terminator 2 as shown by the arrows a1 and a3 of the solid lines in the figure. Then the transmission power is radiated to the outside bit by bit as shown by arrows a6 and a7 of solid lines in the figure on the way of the transmission.

Not having been shown, radio terminal devices are placed around the coaxial cable 1, and the coaxial cable 1 receives the transmission power from the terminal devices as shown by arrows a8 and a9 of dot lines in the figure.

The received power received though the coaxial cable 1 is transmitted as shown by arrows a4 and a2 of the dot lines in the figure.

That is, the received power received in a section 1a between the first coupler 3 and the second coupler 5 is input to the power compositor 7 from the coaxial cable 1 via the first coupler 3 as shown by the arrow a2 of the dot line in the figure.

The received power received in a section 1b between the second coupler 5 and the terminator 2 is transmitted from the coaxial cable 1 to the coaxial cable 4 via the second coupler 5, and further, input to the power compositor 7 through the coaxial cable 4.

The power compositor 7 composes the received power from the first coupler 3 and the received power from the coaxial cable 4 to output the composite power to the output terminal OUT.

Not shown in the figure, each radio base station is connected to the input terminal IN and the output terminal OUT. And the base station each makes radio communications with the radio terminal devices by using the antenna for the radio base station having the structure given above.

In the radio communications with the radio terminal devices, the received power received in the section 1a of the coaxial cable 1 is input to the compositor 7 from the first coupler 3. At this moment, since the distance to the output terminal OUT to which the received power is transmitted is short, the output terminal OUT outputs sufficient received power.

Further, in the radio communications with the radio terminal devices, the received power received in the section 1b of the coaxial cable 1 is input to the power compositor 7 from the second coupler 5 via the coaxial cable 4. At this time, the distance to the output terminal OUT to which the received power is transmitted becomes long. However, the received power having been transmitted via the coaxial cable 4, the transmission loss is made small and the received power is output sufficiently from the output terminal OUT.

Therefore, even if the coaxial cable 1 is made long in length, the coaxial cable 1 can transmit, the received power received from the radio terminal devices in the section 1b to the output terminal OUT without extremely decreasing the received power, by disposing the second coupler 5 and by setting the length of the coaxial cable 4 appropriately.

Accordingly, the antenna for the base station can supply sufficient received power to the base station from the output terminal OUT.

Thereby, the radio base station can assure the distances for the radio communications with the radio terminal devices sufficiently long and make the radio communication ranges wide.

### Second Embodiment

The antenna for the radio base station will be described in accordance with the second embodiment.

In FIG. 2, a leaky coaxial cable 11 constitutes a leaky transmission line. The transmission line may be constituted by a cable other than a coaxial cable.

The coaxial cable 11 inputs transmission power from an input terminal IN to transmit it toward a terminator 12. The coaxial cable 11 transmits received power received from the outside toward the input terminal IN.

The coaxial cable 11 disposes a first directional coupler 13 at a side of the input terminal IN.

The first coupler 13 has a function to pass the transmission power advancing from the input terminal IN to the terminator 12 as shown by an arrow all of a solid line in the figure and a function to output the received power received from the outside and advanced toward the input terminal IN to a below-mentioned power compositor as shown by an arrow a12 of a dot line in the figure.

Further, the coaxial cable 11 disposes a second directional coupler 15 and a third directional coupler 16 in the middle thereof.

The second coupler 15 is disposed on the side of the terminator 12, and has a function to pass the transmission power advancing from the input terminal IN to a terminator 12 as shown by an arrow a13 of a solid line in the figure and a function to bypass and output the received power received from the outside and advanced toward the input terminal IN toward a low-loss coaxial cable 14 as shown by an arrow a14 of a dot line in the figure.

The coaxial cable 14 constitutes a low-loss transmission line and has a transmission loss per unit length smaller than that of the coaxial cable 11. The low-loss transmission line may be constituted by something other then a low-loss coaxial cable.

The third coupler 16 is disposed between the first coupler 13 and the second coupler 15 and has a function to transmit the transmission power advancing from the input terminal IN to the terminator 12 as shown by an arrow a15 of a solid line in the figure and a function to output the received power received from the outside and advanced toward the input terminal IN to a below-mentioned power compositor as shown by an arrow a16 of a dot line in the figure.

A first power compositor 18 is connected to the first coupler 13 through a coaxial cable 17 having an extremely short length. A low-loss coaxial cable 14a is connected to the first power compositor 18.

The coaxial cable 14a constitutes another low-loss transmission line and it has a transmission loss per unit length smaller than that of the coaxial cable 11. The low-loss transmission line may be constituted by something other than a low-loss coaxial cable.

The power compositor 18 inputs the received power output from the first coupler 13 via the coaxial cable 17 and also inputs the received power through the coaxial cable 14a to composite the two pieces of the power.

The received power output from the first coupler 13 may be directly input to the power compositor 18 without using the coaxial cable 17.

A second power compositor 21 is connected with the third coupler 16 via a coaxial cable 20 having an extremely short length.

The received power output from the third coupler 16 may be directly input to the power compositor 21 without using the coaxial cable 20.

The low-loss coaxial cables 14, 14a are connected to the second power compositor 21.

That is to say, the second power compositor 21 is connected to the second coupler 15 via the cable 14. The second power compositor 21 is also connected to the first power compositor 18 via the coaxial cable 14a.

The second power compositor 21 inputs the received power output from the third coupler 16 through the coaxial cable 20 and also inputs the received power output from the second coupler 15 through the coaxial cable 14 to composite the two pieces of the received power.

The second power compositor 21 supplies the composite power to the first power compositor 18 via the coaxial cable 14a as shown by an arrow a18 of a dot line in the figure.

The first power compositor 18 composes the received power from the first coupler 13 and the received power from the coaxial cable 14a to output the composite power as final received power to an output terminal OUT as shown by an arrow a17 of a dot line in the figure.

The transmission power input the input terminal IN of the antenna for the radio base station structured like this is transmitted toward the terminator 12 through the coaxial cable 11 as shown by arrows a11, a15 and a13 of solid lines in the figure and radiated to the outside bit by bit in the middle of the coaxial cable 11 as shown by arrows a19 and a20 of solid lines in the figure.

Not having been shown in the figure, radio terminal devices are disposed around the coaxial cable 11 and the coaxial cable 11 receives transmission power from the terminal devices as shown by arrows a21 and a22 of dot lines in the figure.

The received power received through the coaxial cable 11 is transmitted as shown by arrows a14, a16 and a12 of dot lines in the figure.

That is, the received power received in a section 11a between the first coupler 13 and the third coupler 16 is input to the first power compositor 18 from the coaxial cable 11 via the first coupler 13 as shown by the arrow a12 of the dot line in the figure.

The received power received in a section 11b between the third coupler 16 and the second coupler 15 is input to the second power compositor 21 from the coaxial cable 11 via the third coupler 13 as shown an arrow a16 of a dot line in the figure.

Furthermore, the received power received in a section 11c between the second coupler 15 and the terminator 12 is transmitted to the coaxial cable 14 from the coaxial cable 11 via the second coupler 15 as shown by the arrow a14 of the dot line in the figure.

The second power compositor 21 composes the received power from the third coupler 16 and the received power from the coaxial cable 14 to output the composite power to the coaxial cable 14a.

The first power compositor 18 composes the received power from the first coupler 13 and the received power from the coaxial cable 14a to outputs the composite power to the output terminal OUT.

Not shown in the figure, radio base station is connected to the input terminal IN and the output terminal OUT. And the base station uses the antenna for the radio base station having the structure described above to perform radio communications with the radio terminal devices.

In the radio communications with the radio terminal devices, the received power received in the section 11a of the coaxial cable 11 is input to the first power compositor 18 from the first coupler 13. At this moment, since the distance to the output terminal OUT to which the received power is transmitted is made short, the output terminal OUT outputs sufficient received power therefrom

In the radio communications with the radio terminal devices, the received power received in the section 11b of the coaxial cable 11 is input to the first power compositor 18 from the third coupler 16 through the second power compositor 21 and the coaxial cable 14a. At this instance, the distance to the output terminal OUT to which the received power is transmitted becomes long. However, the received power is transmitted via the low-loss coaxial cable 14a, so that the transmission loss is made small and the received power is output sufficiently from the output terminal OUT.

And in the radio communications with the radio terminal devices, the received power received in the section 11c of the coaxial cable 11 is input to the first power compositor 18 from the second coupler 15 through the coaxial cable 14, the second power compositor 21 and the coaxial cable 14a. At this time, the distance to the output terminal OUT to which the received power is transmitted becomes longer. However, the received power is transmitted via the low-loss coaxial cables 14 and 14a, so that, even in this time, the transmission losses are reduced and the received power is output sufficiently from the output terminal OUT.

Therefore, the coaxial cable therefore can be set longer. That is, arranging the second and third couplers 15 and 16 appropriately and setting the lengths of the coaxial cables 14 and 14a appropriately enables the leaky coaxial cable 11 to transmit the received power without reducing the received power from the radio terminal devices radio-communicating in the section 11c as well as in the sections 11a and 11b even when the coaxial cable is set longer.

Accordingly, the antenna for the base station can supply sufficient received power from the output terminal OUT to the base station.

Thereby, the base station can assure the radio communication distances to the radio terminals devices sufficiently and can expand the radio communication ranges.

Having described the second embodiment in which one of the third coupler 16 is arranged between the first coupler 13 and the second coupler 15, the present invention is not limited by any of the details of description. One or more third couplers 16 may be disposed with prescribed intervals between the first and the second couplers 13 and 15. An increase in the number of the third couplers 16 results in an increase of the number of the second power compositors 21 in response to the increased number of the third couplers 13.

### Third Embodiment

A radio communication system will be described in a third embodiment.

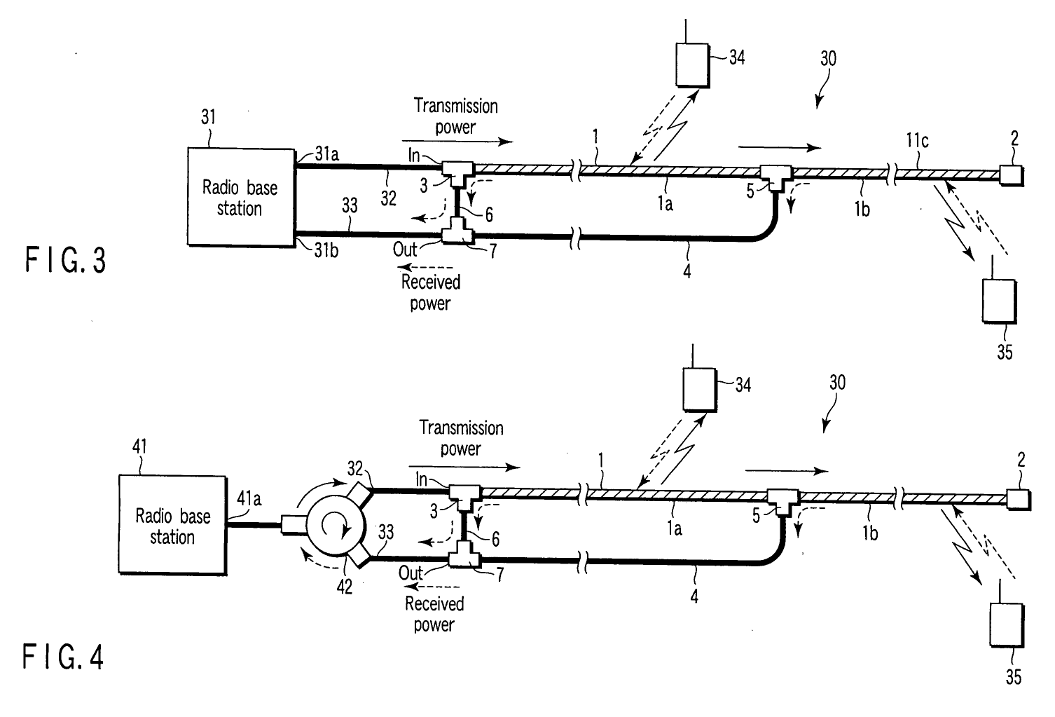

In FIG. 3, a radio base station 31 has a transmitting antenna terminal 31a and a receiving antenna terminal 31b.

The base station 31 connects the antenna terminal 31a with an input terminal IN of an antenna 30 a radio base station via a coaxial cable 32 and also connects the antenna terminal 31b with an output terminal OUT of the antenna 30 via a coaxial cable 33.

The antenna 30 has the same structure as that of the aforementioned first embodiment and composed of the leaky coaxial cable 1, terminator 2, first directional coupler 3, low-loss coaxial cable 4, second directional coupler 5, coaxial cable 6 and power compositor 7.

Radio terminal devices 34 and 35 are disposed around the coaxial cable 1. That is, the terminal device 34 is disposed around the section 1a of the coaxial cable 1. The radio terminal 35 is disposed around the section 1b of the coaxial cable 1.

In this radio communication system, when making radio communications with the terminals devices 34 and 35, the base station 31 outputs transmission power to the input terminal IN of the antenna 30. The transmission power transmits through the coaxial cable 1 by passing through the first and second couplers 3 and 5.

In the section 1a then a radiated radio wave from the coaxial cable 1 is received by the terminal device 34. In the section 1b, the radiated radio wave from the coaxial cable 1 is received by the terminal device 35.

The transmission power from the terminal device 34 is received in the section 1a of the coaxial cable 1. At this moment, the received power received by the coaxial cable 1 is supplied from the section 1a to the power compositor 7 via the first coupler 3 and the coaxial cable 6.

The received power is further input to the antenna terminal 31b of the base station 31 from the power compositor 7 through the output terminal OUT and the coaxial cable 33.

The base station 31 and the terminal device 34 thus can perform a radio communication with each other by using the antenna 30.

The transmission power from the terminal device 35 is received in the section 1b of the coaxial cable 1. The received power received by the coaxial cable 1 is supplied to the power compositor 7 from the section 1b through the second coupler 5 and the coaxial cable 4. The received power is further input to the antenna terminal 31b of the base station 31 from the power compositor 7 through the output terminal OUT and the coaxial cable 33.

The base station 31 and the terminal device 35 thus can radio-communicate with each other by using the antenna 30.

In this configuration, the antenna 30 can output sufficient received power from the output terminal OUT even if the length of the coaxial cable 1 is made sufficiently long. Thereby, the base station 31 can assure radio communication distances with the radio terminal devices sufficiently long.

Accordingly, the base station 31 can communicate with a radio terminal device located extremely away therefrom by using the antenna 30.

The communication system, in which the antenna 30 for the radio base station is connected to the base station 31, can expand a communicable range.

For instance, if the length of the leaky coaxial cable is short as like a conventional communication system, it is needed to arrange a large number of the communication systems in which antennas are connected to radio base stations so as to assure a wide area as a communicable range. In contrast, this third embodiment can expand the communicable range; the number of the systems can be decreased.

By the way, in the communication system, if it is set for a transmission loss of the coaxial cable 1 in the section 1a is to α1 (dB), for a transmission loss of the coaxial cable 4 from a bypass output point of the second coupler 5 to the power compositor 7 is to α2 (dB), for transmission power from the base station 31 is to P1 (dBm) and for transmission power from the radio terminal is to P2 (dBm), and when the following formula (1) is satisfied, the power arrives from the radio terminal device at the base station 31 becomes equal to the power arrives from the base station 31 at the radio terminal device or more.
α1−α2≧P1−P2 (1)

Assuming that both transmission power P1 and P2 are constant, the above-expressed formula (1) can be satisfied by determining α1 in accordance with a transmission loss of the length of the leaky coaxial cable 1 or per unit length and by determining α2 in accordance with a transmission loss of the length of the low-loss coaxial cable 4 or per unit length.

In an actual site such as a tunnel and an under ground road, a rage in which a radio communication is desired to be performed is determined in advance in many cases, then, the length of the leaky coaxial cable to be laid is decided inevitably in response to the range.

For instance, it may be presumed that the whole length L of the coaxial cable 1 to be laid is 200 m, out of it, the sections 1a and 1b are 100 m, respectively, the length of the coaxial cable 4 parallel to the section 1a is 100 m, the transmission power P1 of the base station 31 is 20 dBm, the transmission power P2 of the radio terminal device is 10 dBm, a minimum receiving sensitivities are −80 dBm, respectively, and a maximum distance from the coaxial cable 1 up to the radio terminal device located in a vertical direction is 1.5 m.

A difference between the power transmitted from the base station to transmit through the coaxial cable 1 and arrived at an arbitrary spot in the coaxial cable 1 and the power received by a standard dipole antenna at a point of 1.5 m away from the arbitrary spot in a virtual direction is defined as a coupling loss and the value is supposed to be 65 dB.

One part of the transmission power output from the base station 31 is consumed and becomes a loss owing to a resistance loss in a process of its transmission in the coaxial cable 1. And the other part of the transmission power is radiated as radio waves from each slot on the coaxial cable 1 and becomes a loss. Accordingly, the transmission loss α1 in passing through the coaxial cable 1 becomes a total value of these losses per 1 m.

In such a presumption, for instance, if the radio terminal device is located at a spot of 1.5 m vertically away form the vicinity of a connection unit of the terminator 2 that is the tip of the coaxial cable 1, transmission power Pr1 transmitted from the base station 31 required to arrive at the radio terminal device is expressed by the following formula:
Pr1=P1−(200×α1+65)

The condition so that the terminal device normally performs a received is expressed by a relation of Pr1≧−80 dBm.

Thereby, a relation α1≦0.175 dB is satisfied.

On the other hand, the transmission power transmitted from the radio terminal apparatus, received by a slot at the tip of the coaxial cable 1 after a space transmission by 1.5 m to be transmitted in the section 1b of the coaxial cable 1, and input to the coaxial cable 4 via the second coupler 5 is expressed as follows:
P2−(65+100×α1)

Therefore, transmission power Pr2 of the radio terminal device passes through the coaxial cable 4 of the length of 100 m to arrive at the base station 31 is expressed by the following formula:
Pr2=P2−(65+100×α1)−100×α2

The condition so that the base station 31 conducts a received normally is expressed by a relation of Pr2≧−80 dBm, so that in the case of α1=0.175 dB, a relation of α2≦0.075 dB make sense.

If the transmission loss α1 of the leaky coaxial cable 1 and the transmission loss α2 of the low-loss coaxial cable 4 from the bypass output point of the second coupler 5 to the power compositor 7 are designed in such a manner above described, the radio base station 31 can normally receive a transmission signal from a radio terminal device located at a location at which the transmission signal transmitted by it self can be received normally.

### Fourth Embodiment

A fourth embodiment of the present invention will set forth a radio communication system using an antenna for a radio base station. The antenna for the radio base station in the embodiment has the same structure as that of the first embodiment in FIG. 1.

In FIG. 4, a radio base station 41 has an antenna terminal 41a for transmission/received with a transmission antenna terminal and a received antenna terminal shared therein.

The base station 41 connects the antenna terminal 41a to the first terminal of a circulator 42 having three terminals.

The circulator 42 connects the second terminal to the input terminal IN of the antenna 30 for radio base station 30 via the coaxial cable 32 and connects the third terminal to the output terminal OUT of the antenna 30 via the coaxial cable 33.

In such a structure, the transmission power from the base station 41 is input to the input terminal IN of the antenna 30 via the circulator 42 and the coaxial cable 32. The transmission power input to the input terminal IN is then radiated to the outside, while transmitting in the leaky coaxial cable 1.

The received power received by the coaxial cable 1 from the outside is transmitted through the coaxial cable 1 and the low-loss coaxial cable 4 to input to the power compositor 7. The received power output to the output terminal OUT from the power compositor 7 is received by the base station 41 through the coaxial cable 33 and the circulator 42.

Thus, the base station 41 can make radio communications with the radio terminal devices 34 and 35 disposed around the coaxial cable 1.

Accordingly, even in this embodiment, the antenna 30 acts the same functions as those of the foregoing third embodiment. Consequently, this fourth embodiment has the same actions and effects as those of the third embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An antenna for a radio base station, comprising:
a leaky transmission line which transmits transmission power from an input terminal toward a terminator and transmits received power toward the input terminal;
a low-loss transmission line which has a transmission loss per unit length smaller than that of the leaky transmission line;
a first directional coupler which is disposed near the input terminal of the leaky transmission line and has a function to pass the transmission power advancing from the input terminal to the terminator and a function to output the received power advancing to the input terminal to the outside;
a second directional coupler which is disposed in the middle of the leaky transmission line and has a function to pass the transmission power advancing from the input terminal to the terminator and a function to bypass and output the received power advancing to the input terminal to the low-loss transmission line; and
a power compositor which is disposed correspondingly to the first directional coupler, inputs the received power output from the first directional coupler and the received power from the low-loss transmission line and outputs its composite power to an output terminal.

2. The antenna for the radio base station according to claim 1, wherein the leaky transmission line is a leaky coaxial cable.

3. The antenna for the radio base station according to claim 1, wherein the low-loss transmission line is a low-loss coaxial cable.

4. The antenna for the radio base station according to claim 1, wherein the first directional coupler and the power compositor are connected by a coaxial cable.

5. The antenna for the radio base station according to claim 1, wherein the first directional coupler and the power compositor are directly connected with each other.

6. The antenna for the radio base station according to claim 1, wherein the first and the second directional couplers and the power compositor are disposed so as to satisfy a relation of α1−α2≧P1−P2, if it is set that a transmission loss of the leaky transmission line between the first directional coupler and the second directional coupler is α1 (dB), a transmission loss of a low-loss transmission line from a bypass output point of the second directional coupler to the power compositor is α2 (dB), transmission power from the input terminal is P1 (dBm) and transmission power received by the leaky transmission line is P2 (dBm).

7. The antenna for the radio base station according to claim 1, wherein the antenna disposes, between the first directional coupler and the second directional coupler in the leaky transmission line, one or more third directional couplers each having a function to transmit the transmission power advancing from the input terminal to the terminator and a function to output the received power advancing to the input terminal to the outside from the leaky transmission line; and disposes a second power compositor, in the middle of the low-loss transmission line correspondingly to one or more third directional couplers, respectively, to input received power output from the one or more third directional couplers and the received power from the low-loss transmission line on a second directional coupler side and to output its composite power to a low-loss transmission line on a received output terminal side.

8. The antenna for the radio base station according to claim 7, wherein the one or more third directional couplers and the second power compositor are connected by coaxial cables, respectively.

9. The antenna for the radio base station according to claim 7, wherein the one or more third directional couplers and the second power compositor are directly connected with each other.

10. An antenna for a radio base station, comprising:
leaky transmission means for transmitting transmission power from an input terminal to a terminator and also transmitting received power to the input terminal;
low-loss transmission means having a transmission loss per unit length smaller than that of the leaky transmission means;
a first directional coupling means for being disposed near the input terminal of the leaky transmission means and having a function to pass the transmission power advancing from the input terminal to the terminator and a function to output the received power advancing to the input terminal to the outside;
a second directional coupling means for being disposed in the middle of the leaky transmission means and having a function to pass the transmission power advancing from the input terminal to the terminator and a function to bypass and output the received power advancing to the input terminal to the low-loss transmission means; and
a power composing means for being disposed correspondingly to the first directional coupling means and inputting the received power output from the first directional coupling means and the received power from the low-loss transmission means to output its composite power to an output terminal.

11. The antenna for the radio base station according to claim 10, wherein the first and the second directional coupling means and the power composing means are disposed so as to satisfy a relation of α1−α2≧P1−P2, if it is set that a transmission loss of the leaky transmission path between the first directional coupling means and the second directional coupling means is α1 (dB), a transmission loss of a small-loss transmission path from a bypass output point of the second directional coupling means to the power compositing means is α2 (dB), transmission power from the input terminal is P1 (dBm) and transmission power received by the leaky transmission path is P2 (dBm).

12. The antenna for the radio base station according to claim 10, wherein the antenna disposes, between the first directional coupling means and the second directional coupling means in the leaky transmission means, one or more third directional coupling means each having a function to transmit the transmission power advancing from the input terminal to the terminator and a function to output the received power advancing to the input terminal from the leaky transmission means to the outside; and disposes, in the middle of the low-loss transmission means correspondingly to the one or more third directional coupling means, a second power composing means for inputting the received power output from the one or more third directional coupling means and the received power from the low-loss transmission means on a second directional coupling means side to output its composite power to the low-loss transmission means on a received output terminal side.

13. A radio communication system, comprising:
an antenna for a radio base station provided with a leaky transmission line which transmits transmission power from an input terminal toward a terminator and transmits received power toward the input terminal; a low-loss transmission line having a transmission loss per unit length smaller than that of the leaky transmission line; a first directional coupler which is disposed near the input terminal of the leaky transmission line and has a function to pass transmission power advancing from the input terminal to the terminator and a function to output the received power advancing to the input terminal to the outside; a second directional coupler which is disposed in the middle of the leaky transmission line and has a function to pass the transmission power advancing from the input terminal to the terminator and a function to bypass and output the received power advancing to the input terminal to the low-loss transmission line; and a power compositor which is disposed correspondingly to the first directional coupler, inputs the received power output from the first directional coupler and the received power from the low-loss transmission line and outputs its composite power to an output terminal;
a radio base station to which the antenna for the radio base station is connected and which transmits transmission power to a transmission input terminal of the leaky transmission line to receive received power from a received output terminal; and
a radio terminal device which performs transmission/received to and from the leaky transmission line in radio and transmits transmission power smaller than that of the radio base station.
